(19) United States
(12) Patent Application Publication
(10) Pub. No.: US 2015/0229520 A1
(43) Pub. Date: Aug. 13, 2015

(54) NETWORK MONITORING SYSTEM, COMMUNICATION DEVICE, NETWORK MANAGEMENT METHOD

(71) Applicant: NEC Corporation, Tokyo (JP)

(72) Inventor: Akira Ichikawa, Tokyo (JP)

(21) Appl. No.: 14/422,229

(22) PCT Filed: Aug. 26, 2013
(86) PCT No.: PCT/JP2013/005006

§ 371 Date: Feb. 18, 2015

(30) Foreign Application Priority Data
Aug. 29, 2012 (JP) 2012-188521

(51) Int. Cl. H04L 12/24; H04L 29/08; H04L 29/12; H04L 12/26

(52) U.S. Cl. CPC H04L 41/0806; H04L 43/04; H04L 67/10; H04L 61/2015

(57) ABSTRACT

Provided is a network monitoring system in which with respect to network management of a node, automatic setting can be realized, traffic can be suppressed, and an address space required for assigning an address can be reduced.

A communication device which includes a host configuration server for providing an address belonging to the address space shared by an entire network to the node connected to one subnet, means for setting information for collecting and setting management information of the node, a management manager for transmitting/receiving the management information to/from the node, and a management agent for transmitting/receiving the management information to/from the network management system; a network management system which acts as the management manager to the communication device and identifies the node by using an identifier other than the address or a combination of the identifier and the address; and a node which acts both as a host configuration client and as the management agent to the communication device are included.

### TECHNICAL FIELD

The present invention relates to a technical field of a network monitoring system, a communication device, a network management method, and a network management program storage medium. In particular, the present invention relates to a network monitoring system in which parameters related to network management are automatically set when a network node is added to a network, a communication device, a network management method, and a network management program storage medium.

### BACKGROUND ART

In order to establish a network monitoring system using SNMP (Simple Network Management Protocol), it is necessary to set IP (Internet Protocol) address or the like and parameters related to network management to a network node that is a monitoring target. Generally, the above-mentioned setting is complex. Therefore, it is desirable that the setting can be easily made as much as possible.

When the number of network nodes monitored by a network management system greatly increases, network traffic for network management greatly increases. In the above-mentioned case, it is desirable that the network traffic is suppressed.

An example of the network monitoring system in which a time required for setting the parameters related to network management to the network node can be reduced is disclosed in patent literature 1. The network system disclosed in patent literature 1 includes a monitoring server, a client node, a network information management server, and a LAN (Local Area Network). The monitoring server includes an SNMP manager, a monitor control table, and a monitor control unit. The client node includes a DHCP (Dynamic Host Configuration Protocol) client and an SNMP agent. The network information management server includes a DHCP server, the SNMP agent, and a network information management table. The network information management table holds a MAC (Media Access Control) address, an IP address, a netmask, a source IP address of SNMP, a community name of SNMP, an access right of an SNMP MIB (Management Information Base), and a notification configuration of SNMP TRAP. The network system disclosed in patent literature 1 operates as follows.

When the client node is connected to the network, the DHCP client requests the network information management server to assign IP information (information including the MAC address, the IP address, and the netmask) and network management information (information including the source IP address of SNMP, the community name of SNMP, the access right of the SNMP MIB, and the notification configuration of SNMP TRAP). When the DHCP server of the network information management server receives the request to assign the IP information and the network management information from the client node, the DHCP server of the network information management server holds the IP information and the network management information assigned to the client node in the network information management table and sends the IP information and the network management information to the client node. The DHCP client sets the IP information and the network management information acquired from the DHCP server to the client node. The SNMP agent of the client node notifies the monitoring server of information indicating the completion of setting the network management information. When the SNMP manager of the monitoring server detects the completion of setting the network management information based on the notification from the SNMP agent of the client node, the monitor control unit records the information of the client node in the monitor control table and performs the monitoring.

As a result of the above-mentioned operation, in the network system described in patent literature 1, when the client node is connected to the network, the IP information and the network management information are automatically set to the client node. After the monitoring server is notified of the information indicating the completion of setting the network management information to the client node, the monitoring server can perform the monitoring of the client node. Namely, a time required for setting the parameters related to network management to the network node can be reduced.

An example of the network monitoring system in which the network traffic for network management is suppressed is disclosed in patent literature 2. The network monitoring system disclosed in patent literature 2 includes a network management system, a communication device (a router, a switch, or the like), a management agent, and a network. The network includes a plurality of branch subnets connected to a wide area communication network. One management agent and one or more communication devices are connected to one branch subnet. The network management system is connected to the wide area communication network. The network management system includes the SNMP manager. The communication device includes the SNMP agent. The management agent includes the SNMP agent and the SNMP manager. The network monitoring system disclosed in patent literature 2 operates as follows.

Each management agent operates as the SNMP manager to all the communication devices in the branch subnet including the management agent and thereby monitors and controls the communication devices. The management agent operates as the SNMP agent which acts as the proxy for the communication devices monitored and controlled by the management agent to the network management system.

As a result of the above-mentioned operation, in the network monitoring system disclosed in patent literature 2, the network management system may monitor and control the management agent instead of directly monitoring and controlling the communication device. Therefore, the network traffic for network management is suppressed.

### CITATION LIST

### Patent Literature

[PTL 1] Japanese Patent Application Laid-Open No. 2006-222929 (pp. 7-14, FIG. 1, and FIG. 10)

[PTL 2] Japanese Patent Application Laid-Open No. 2008-117096 (pp. 3-4 and FIG. 1)

### SUMMARY OF INVENTION

### Technical Problem

In the network monitoring system disclosed in patent literature 1, the network traffic for network management of all the client nodes concentrate on one monitoring server. Therefore, the network monitoring system disclosed in patent literature 1 has a problem in which the network traffic for network management greatly increases when the number of the clients that are the monitoring targets greatly increases.

In the network monitoring system described in PTL 2, the IP address overlap between different subnets is not allowed. Therefore, a unique IP address is assigned to each communication device in the network. Accordingly, the network monitoring system described in PTL 2 has a problem in which a large IP address space is necessary.

An object of the present invention is to provide a network monitoring system in which an automatic configuration for network management of a network node can be realized, network traffic for network management can be suppressed, and an address space required for assigning a network address for network management can be reduced, a communication device, a network management method, and a network management program storage medium.

### Solution to Problem

The network monitoring system of the present invention is characterized by comprising a communication device which includes a host configuration server for providing network configuration information including a network address belonging to a network address space shared by an entire network to a network node connected to one subnet, information setting means for configuration information for collecting and setting management information of the network node, a management manager for transmitting a request for the management information to the network node, receiving a response from the network node, and receiving a notification of update of the management information from the network node, and a management agent for receiving the request from the network management system which manages the management information, transmitting the response to the network management system, and transmitting the notification to the network management system, the network management system which acts as the management manager to the communication device and identifies each of a plurality of the network nodes by using an identifier other than a network address or a combination of the network address and the identifier other than the network address, and the network node which acts both as a host configuration client that communicates with the host configuration server and as the management agent to the communication device and is identified by using the identifier other than the network address or the combination of the network address and the identifier other than the network address.

A communication device of the present invention is characterized by comprising a host configuration server for providing network configuration information including a network address belonging to a network address space shared by an entire network to a network node connected to one subnet, information setting means for configuration information for collecting and setting management information of the network node, a management manager for transmitting a request for the management information to the network node, receiving a response from the network node, and receiving a notification of update of the management information from the network node, and a management agent for receiving the request from the network management system which manages the management information of the network node, transmitting the response to the network management system, and transmitting the notification to the network management system.

A network management method of the present invention is characterized by comprising the steps of: providing network configuration information including a network address belonging to a network address space shared by an entire network to a network node connected to one subnet; configuration information for collecting and setting management information of the network node; transmitting a request for the management information to the network node, receiving a response from the network node, and receiving a notification of update of the management information from the network node; and receiving the request from the network management system which manages the management information of the network node, transmitting the response to the network management system, and transmitting the notification to the network management system.

A network management program storage medium of the present invention is characterized by storing a program which causes a computer provided in a communication device to function as means for providing network configuration information including a network address belonging to a network address space shared by an entire network to a network node connected to one subnet; means for setting information for collecting and setting management information of the network node; means for transmitting a request for the management information to the network node, receiving a response from the network node, and receiving a notification of update of the management information from the network node; and means for receiving the request from the network management system which manages the management information of the network node, transmitting the response to the network management system, and transmitting the notification to the network management system.

### Advantageous Effects of Invention

By using the present invention, an automatic configuration for network management of a network node can be realized, network traffic for network management can be suppressed, and an address space required for assigning a network address for network management can be reduced.

### BRIEF DESCRIPTION OF DRAWINGS

FIG. 1 is a block diagram showing a configuration of a network monitoring system, a network management system, a communication device, and a network node according to an exemplary embodiment of the present invention.

FIG. 2 is a block diagram showing an example of a hardware configuration of a communication device according to an exemplary embodiment of the present invention.

FIG. 3 is a sequence chart for explaining operation of setting network configuration information and network management protocol information of a network monitoring system according to an exemplary embodiment of the present invention.

FIG. 4 is a sequence chart for explaining operation of collecting management information of the network monitoring system according to an exemplary embodiment of the present invention.

FIG. 5 is a sequence chart showing an example of a protocol sequence for explaining operation of setting network configuration information and network management protocol information of a network monitoring system according to an exemplary embodiment of the present invention.

FIG. 6 is a sequence chart showing an example of a protocol sequence for explaining operation of collecting management information of a network monitoring system according to an exemplary embodiment of the present invention.

### DESCRIPTION OF EMBODIMENTS

An exemplary embodiment of the present invention will be described in detail below with reference to the drawing. Further, the same reference numbers are used for the elements having a similar function in all the drawings and the description is omitted appropriately.

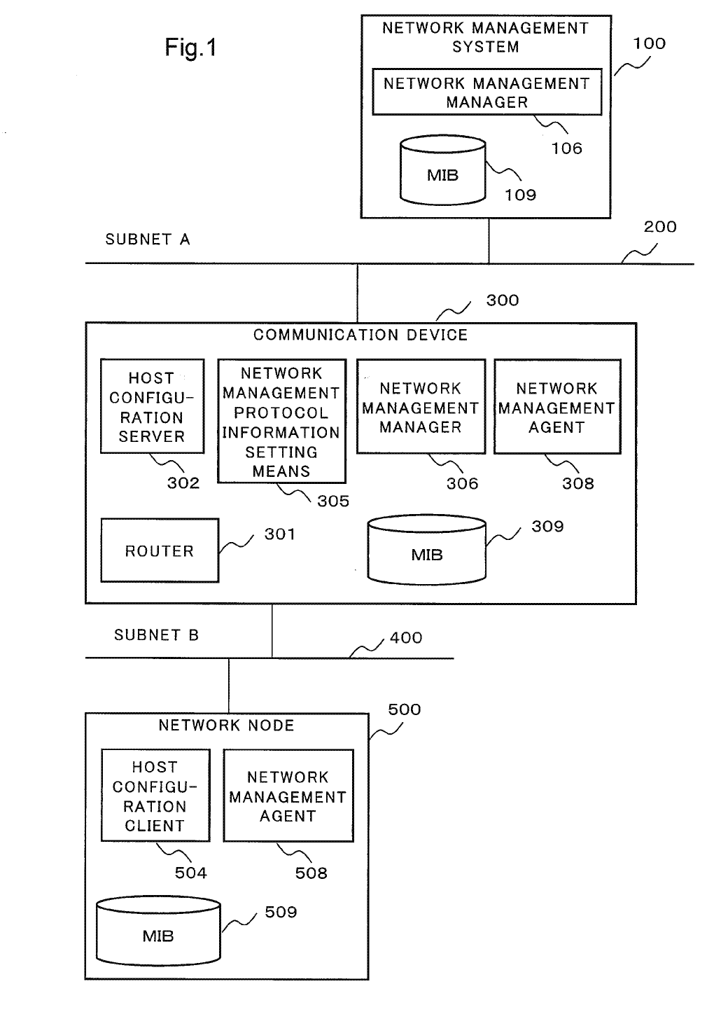

FIG. 1 is a block diagram showing a configuration of a network monitoring system according to an exemplary embodiment of the present invention.

The network monitoring system according to this exemplary embodiment includes a network management system 100, a communication device 300, a network node 500, a subnet A 200, and a subnet B 400. Hereinafter, the reference numbers of the subnet A 200 and the subnet B 400 will be omitted.

Further, the number of the communication devices and the number of the subnets other than the subnet A (in FIG. 1, the number of subnets B) are one or more, respectively. FIG. 1 shows a case in which the number of the communication devices is one and the number of the subnets other than the subnet A is one as an example. The number of the network nodes connected to one subnet excluding the subnet A (in FIG. 1, the subnet B) is one or more. FIG. 1 shows a case in which the number of the network nodes is one as an example. A case in which the communication device 300 includes a router 301 will be described below as an example. The communication device 300 may exist in the subnet B independently of the router.

The network management system 100 manages fault monitoring, operation, and the like of the network node 500 included in the network. However, the network management system 100 does not communicate with the network node 500 directly but communicates the network node 500 via the communication device 300.

The network management system 100 does not identify the network node 500 by referring to only the network address. The network management system 100 identifies the network node 500 by using a set of the network address of the network node 500 and the network address, the name, the identifier, or the like of the communication device 300. Alternatively, the network management system 100 identifies the network node 500 by using the name, the identifier, the physical address, or the like that is uniquely assigned to the network node 500.

The network management system 100 includes a network management manager 106. The network management manager 106 receives a notification of update of the management information of the network node 500 and issues a command to the network node 500 according to a network management protocol (hereinafter, referred to as “NMP”). Further, the NMP in this exemplary embodiment is an NMP which allows the node to act as a server to the client and act as a proxy of the client to the server.

The network node 500 is a general network device such as a router, a switch, or a computer. The network node 500 includes a host configuration client 504 and a network management agent 508. The host configuration client 504 requests a host configuration server 302 to assign a network address or the like according to a host configuration protocol. The network management agent 508 issues the notification of update of the management information to a network management manager 306 and receives a command from the network management manager 306 according to the MNP. Further, the host configuration protocol in this exemplary embodiment is a host configuration protocol which dynamically gives one network address to the client from a specific network address space.

The communication device 300 includes the router 301, the host configuration server 302, network management protocol information setting means (hereinafter, referred to as “NMP information setting means”) 305, the network management manager 306, and a network management agent 308. The communication device 300 acts as the network management agent to the network management system 100. The communication device 300 acts as the network management manager and the host configuration server to the network node 500.

The router 301 performs routing of a network packet between the subnet A and the subnet B. Further, the router 301 assumes the network address which can be assigned by the host configuration server 302 exists in the subnet B and performs the routing. For example, the network node 500 communicates with the network management system 100 via the communication device 300 at all times. The network node 500 does not communicate with the network node which exists in the subnet other than the subnet B.

The host configuration server 302 notifies the host configuration client 504 of the network node 500 of the configuration information such as the network address or the like according to the host configuration protocol.

The NMP information setting means 305 generates network management protocol information (hereinafter, referred to as “NMP information”) and notifies the network node 500 of the generated NMP information.

The network management manager 306 receives the notification of update of the management information from the network node 500 and issues the command to the network node 500 according to the NMP.

The network management agent 308 sends the notification of update of the management information of the network node 500 to the network management manager 106 of the network management system 100 and receives the command to the network node 500 from the network management system 100 according to the NMP.

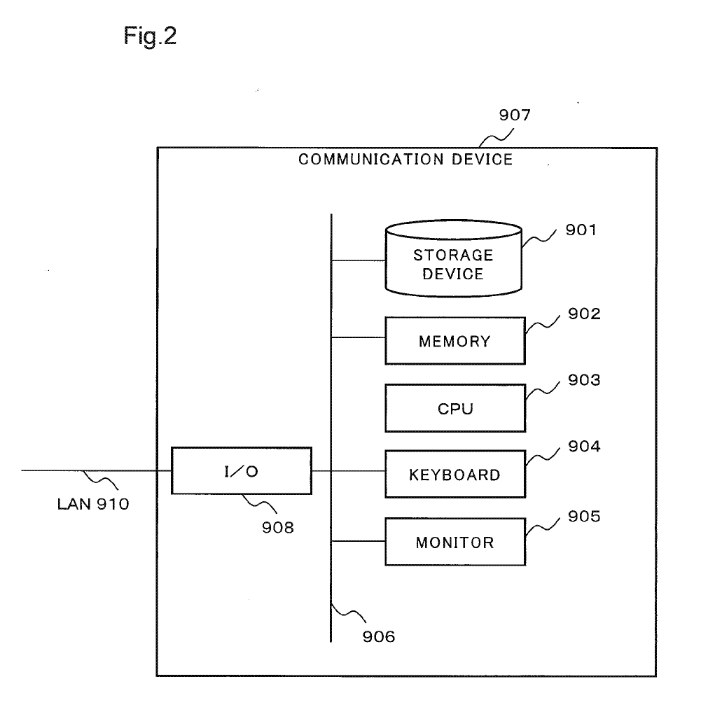

FIG. 2 is a block diagram showing an example of a hardware configuration of a communication device 907 that is an example of the communication device 300.

The communication device 907 communicates with the network management system 100, the network node 500, and the like via a LAN 910. The communication device 907 includes a storage device 901, a memory 902, a CPU (Central Processing Unit) 903, a keyboard 904, a monitor 905, and an I/O (Input/Output) 908 and these elements are connected to each other via an internal bus 906. The I/O 908 is connected to the LAN 910. The LAN 910 is an interface through which the communication device 907 communicates with the network management system 100, the network node 500, and the like. The CPU 903 controls the entire communication device907, executes the program of the NMP information setting means 305 and the like via the I/O 908, and performs transmission/reception of data. The memory 902 stores an operation program and the like of the CPU 903. The storage device 901 stores the program of the NMP information setting means 305 and the like. Further, the internal configuration of the communication device 907 described above is shown as an example. The communication device 907 may include only the CPU 903 and operate by using the storage device 901, the memory 902, the keyboard 904, the monitor 905, and the I/O 908 that are provided at the outside.

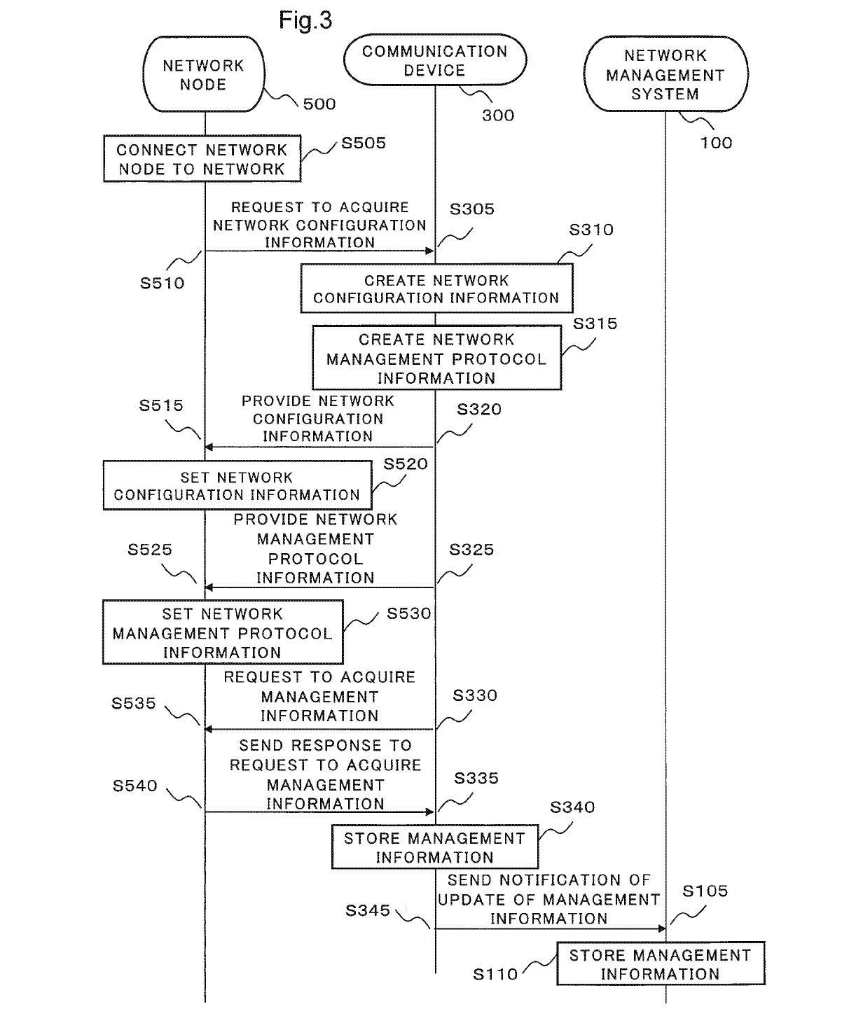

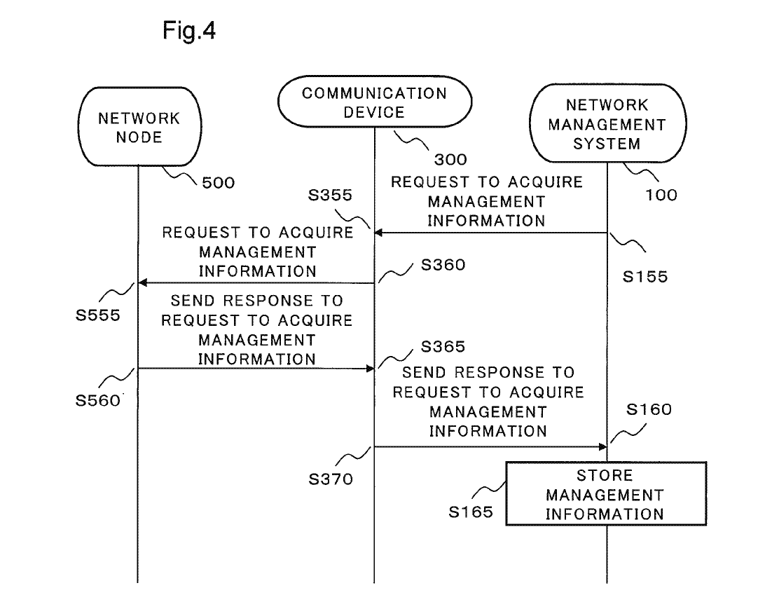

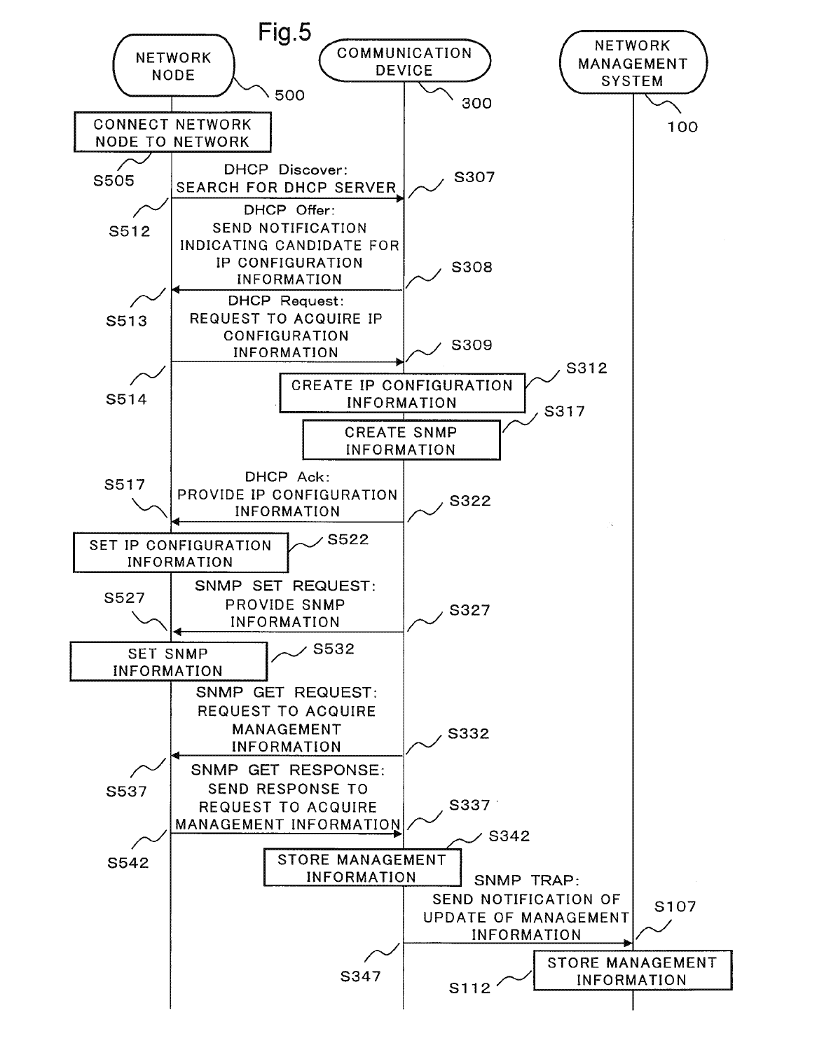

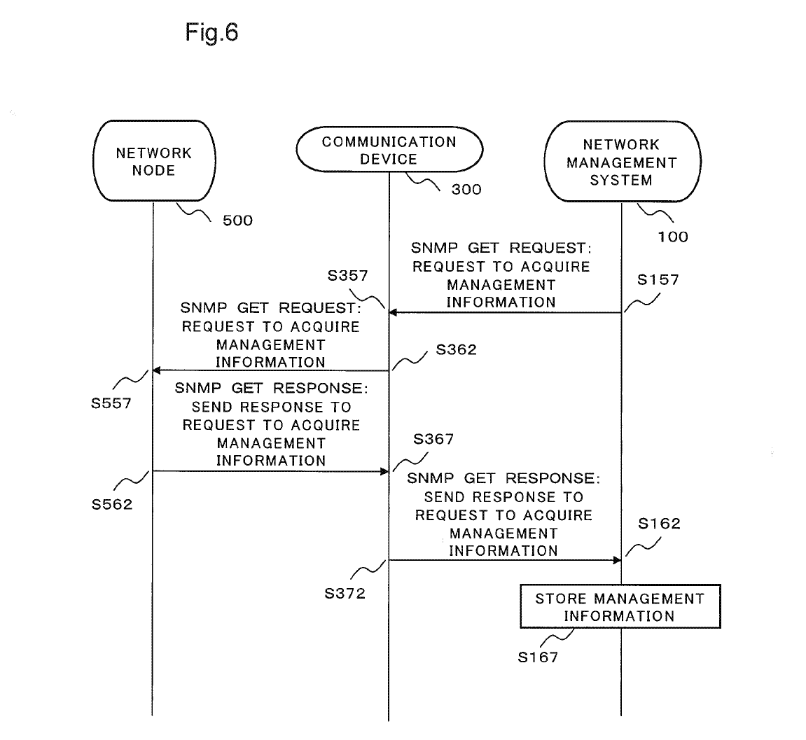

Next, operation of this exemplary embodiment will be described. FIG. 3 shows the operation of setting the network configuration information and the NMP information. FIG. 4 shows the operation of collecting the management information after the network configuration information and the NMP information are set. FIG. 5 shows the operation of setting the network configuration information and the NMP information in a case in which SNMP is used as the NMP and DHCP is used as the host configuration protocol. FIG. 6 shows the operation of collecting the management information after the network configuration information and the NMP information are set in the case in which SNMP is used as the NMP and DHCP is used as the host configuration protocol.

FIG. 3 is a sequence chart for explaining the operation of setting the network configuration information and the NMP information of the network monitoring system according to the exemplary embodiment.

In this example of the operation, a case in which the network node 500 is newly connected to the subnet B will be described.

When the network node 500 is connected to the subnet B (step S505), the host configuration client 504 of the network node 500 requests the communication device 300 to acquire the network configuration information such as the network address or the like (step S510).

The host configuration server 302 of the communication device 300 receives the request to acquire the network configuration information from the network node 500 (step S305). The host configuration server 302 creates the network configuration information (step S310). The network configuration information includes the network address belonging to the network address space shared by a plurality of the subnets. The network address included in the network configuration information and the network address of another network node may overlap each other.

The NMP information setting means 305 of the communication device 300 creates the NMP information (step S315). The NMP information includes the network address of the communication device 300 which acts as a network management protocol manager (hereinafter, referred to as “NMP manager”) to the network node 500. The NMP information may include authentication information or the like included in the NMP.

The host configuration server 302 of the communication device 300 provides the network configuration information to the network node 500 (step S320).

The NMP information setting means 305 of the communication device 300 provides the NMP information to the network node 500 (step S325).

The host configuration client 504 of the network node 500 acquires the network configuration information from the communication device 300 (step S515). The host configuration client 504 sets the acquired network configuration information to the network node 500 (step S520). The network management agent 508 of the network node 500 acquires the NMP information from the communication device 300 (step S525). The network management agent 508 sets the acquired NMP information to the network node 500 (step S530).

The network management manager 306 of the communication device 300 requests the network node 500 to acquire the management information (step S330).

The network management agent 508 of the network node 500 receives the request to acquire the management information from the communication device 300 (step S535). The network management agent 508 notifies the communication device 300 of the management information (step S540). In this example of the operation, the network node 500 is identified by using a physical address of the network node 500 in the management information. Further, in this example of the operation, a case in which the network node 500 is identified by using the physical address in the management information is shown as an example. The network node 500 may be identified by using a set of the network address of the network node 500 and the network address, the name, the identifier or the like of the communication device 300 in the management information. Alternatively, the network node 500 may be identified by using the name, the identifier, the address, or the like that is uniquely assigned to the network node 500 in the management information.

The network management agent 308 of the communication device 300 receives the management information from the network node 500 (step S335). The network management agent 308 stores the received management information (step S340). The network management agent 308 of the communication device 300 notifies the network management system 100 of the stored management information (step S345).

The network management manager 106 of the network management system 100 receives the management information of the network node 500 from the communication device 300 (step S105). The network management manager 106 stores the received management information (step S110). In this example of the operation, the network node 500 is identified by using the physical address of the network node 500 in the management information. The network management system 100 identifies the network node 500 by using the physical address in the management information. Therefore, the network management system 100 can discriminate the network node 500 from another network node with the same network address as the network node 500. Even when the network node 500 is identified by using the set of the network address of the network node 500 and the network address, the name, the identifier, or the like of the communication device 300, the network management system 100 can discriminate the network node 500 from the another network node with the same network address as the network node 500. Further, even when the network node 500 is identified by using the name, the identifier, the address, or the like that is uniquely assigned to the network node 500, the network management system 100 can discriminate the network node 500 from the another network node with the same network address as the network node 500. Further, the network management system 100 may update a screen display or the like based on the update of the management information.

FIG. 4 is a sequence chart for explaining the operation of collecting the management information of the network monitoring system according to this exemplary embodiment.

In this example of the operation, a case in which the network management system 100 collects the management information of the network node 500 will described.

The network management system 100 requests the communication device 300 to acquire the management information of the network node 500 (step S155).

The communication device 300 receives the request to acquire the management information from the network management system 100 (step S355). The communication device 300 requests the network node 500 to acquire the management information of the network node 500 (step S360).

The network node 500 receives the request to acquire the management information from the communication device 300 (step S555). The network node 500 notifies the communication device 300 of the management information of the network node 500 (step S560).

The communication device 300 receives the management information from the network node 500 (step S365). The communication device 300 notifies the network management system 100 of the management information of the network node 500 (step S370).

The network management system 100 receives the management information from the communication device 300 (step S160). The network management system 100 stores the management information of the network node 500 (step S165). In this example of the operation, the network node 500 is identified by using the physical address of the network node 500 in the management information. The network management system 100 identifies the network node 500 by using the physical address in the management information. Therefore, the network management system 100 can discriminate the network node 500 from the another network node with the same network address as the network node 500. Even when the network node 500 is identified by using the set of the network address of the network node 500 and the network address, the name, the identifier, or the like of the communication device 300 in the management information, the network management system 100 can discriminate the network node 500 from the another network node with the same network address as the network node 500. Further, even when the network node 500 is identified by using the name, the identifier, the address, or the like that is uniquely assigned to the network node 500 in the management information, the network management system 100 can discriminate the network node 500 from the another network node with the same network address as the network node 500.

FIG. 5 is a sequence chart showing an example of a protocol sequence for explaining operation of setting the network configuration information and the NMP information of the network monitoring system according to the exemplary embodiment.

In this example of the operation, a case in which the network node 500 is connected to the subnet B will be described. Further, in FIG. 5, the same reference numbers are used for the processes which perform the same operations as those shown in FIG. 3. Therefore, the description of the process will be omitted appropriately.

When the network node 500 is connected to the subnet B (step S505), the host configuration client 504 of the network node 500 requests the subnet B to search for a DHCP server by using a DHCP Discover (step S512).

The host configuration server 302 of the communication device 300 receives the request to search for the DHCP server by using the DHCP Discover from the network node 500 (step S307). The host configuration server 302 notifies the host configuration client 504 of the network node 500 of a candidate for the network configuration information by using a DHCP Offer (step S308).

The host configuration client 504 of the network node 500 receives the candidate for the network configuration information by using the DHCP Offer from the communication device 300 (step S513). The host configuration client 504 requests the host configuration server 302 of the communication device 300 to acquire the network configuration information including the network address and the like by using a DHCP Request (Step S514).

The host configuration server 302 of the communication device 300 receives the request to acquire the network configuration information including the network address and the like by using the DHCP Request from the network node 500 (step S309). The host configuration server 302 creates the network configuration information (step S312). Because the network configuration information includes the IP addresses belonging to the IP address space shared by the subnets, the IP addresses included in the network configuration information may overlap each other.

The NMP information setting means 305 of the communication device 300 create the NMP information (step S317). In this example of the operation, the NMP information includes the IP address of the communication device 300 which acts as the SNMP manager to the network node 500. The NMP information may include SNMP community names (when SNMP v1 or SNMP v2 is used), a user name, an authentication password, an encrypted password (when SNMP v3 is used), or the like.

The host configuration server 302 of the communication device 300 provides the network configuration information by using a DHCP Ack to the network node 500 (step S322). The NMP information setting means 305 of the communication device 300 provide the NMP information by using an SNMP SET REQUEST to the network node 500 (step S327).

The host configuration client 504 of the network node 500 acquires the network configuration information by using the DHCP Ack from the communication device 300 (step S517). The host configuration client 504 sets the acquired network configuration information to the network node 500 (step S522). The network management agent 508 of the network node 500 acquires the NMP information by using the SNMP SET REQUEST from the communication device 300 (step S527). The network management agent 508 sets the acquired NMP information to the network node 500 (step S532).

The network management manager 306 of the communication device 300 requests the network node 500 to acquire the management information by using an SNMP GET REQUEST (step S332).

The network management agent 508 of the network node 500 receives the request to acquire the management information from the communication device 300 (step 537). The network management agent 508 notifies the communication device 300 of the management information of the network node 500 by using an SNMP GET RESPONSE (step S542). The network node 500 is identified by using the MAC address of the network node 500 in the management information. Further, in this example of the operation, the case in which the network node 500 is identified by using the MAC address in the management information has been explained as example. The network node 500 may be identified by using the set of the network address of the network node 500 and the network address, the name, the identifier, or the like of the communication device 300 in the management information. Alternatively, the network node 500 may be identified by using the name, the identifier, the address, or the like that is uniquely assigned to the network node 500 in the management information.

The network management agent 308 of the communication device 300 receives the management information by using the SNMP GET RESPONSE from the network node 500 (step S337). The network management agent 308 stores the received management information (step S342). The network management agent 308 of the communication device 300 notifies the network management system 100 of the stored management information by using an SNMP TRAP (step S347).

The network management manager 106 of the network management system 100 receives the management information of the network node 500 by using the SNMP TRAP from the communication device 300 (step S107). The network management manager 106 stores the received management information (step S112). Here, the network node 500 is identified by using the MAC address of the network node 500 in the management information. The network management system 100 identifies the network node 500 by using the MAC address in the management information. Therefore, the network management system 100 can discriminate the network node 500 from the another network node with the same network address as the network node 500. Further, the network management system 100 may update the screen display or the like based on the update of the management information.

FIG. 6 is a sequence chart showing an example of a protocol sequence for explaining the operation of collecting the management information of the network monitoring system according to the exemplary embodiment.

In this example of operation, a case in which the network management system 100 collects the management information of the network node 500 will be described. Further, in FIG. 6, the same reference numbers are used for the processes which perform the same operations as those shown in FIG. 4. Therefore, the description of the process will be omitted appropriately.

The network management system 100 requests the communication device 300 to acquire the management information of the network node 500 by using the SNMP GET REQUEST (step S157).

The communication device 300 receives the request to acquire the management information by using the SNMP GET REQUEST from the network management system 100 (step S357). The communication device 300 requests the network node 500 to acquire the management information of the network node 500 by using the SNMP GET REQUEST (step S362).

The network node 500 receives the request to acquire the management information by using the SNMP GET REQUEST from the communication device 300 (step S557). The network node 500 notifies the communication device 300 of the management information of the network node 500 by using the SNMP GET RESPONSE (step S562).

The communication device 300 receives the management information by using the SNMP GET RESPONSE from the network node 500 (step S367). The communication device 300 notifies the network management system 100 of the management information of the network node 500 by using the SNMP GET RESPONSE (step S372).

The network management system 100 receives the management information by using the SNMP GET RESPONSE from the communication device 300 (step S162). The network management system 100 stores the management information of the network node 500 (step S167).

Further, the communication device 907 shown in FIG. 2 performs the operation performed by the communication device 300 among the operations shown in FIGS. 3 to 6.

Further, in this example of the operation, the case in which the SNMP GET REQUEST is used has been explained as an example. However, in this exemplary embodiment, a combination of an SNMP GETNEXT REQUEST, an SNMP GETBULK REQUEST, and the like may be used.

As described above, the network (in the above explanation, the network including the subnet A and the subnet B) in the exemplary embodiment is divided into the subnets (in the above explanation, the subnets B) by taking into consideration the suppression of network traffic. Therefore, the network addresses of the network nodes can overlap each other between the subnets. Accordingly, the network monitoring system in this exemplary embodiment can reduce the network address space required when an automatic setting of the network and the NMP information of the network node is realized.

Further, in the above-mentioned example of the operation, the case in which SNMP is used as the NMP has been described as an example. However, in the exemplary embodiment, it is not limited to SNMP. The NMP has to be a kind of protocol which allows a node to act as a server to a client and act as an another client to an another server simultaneously. For example, the NMP may be CMIP (Common Management Information Protocol) or WS-Management (Web Service for Management). In the above-mentioned example of the operation, the case in which DHCP is used as the host configuration protocol has been shown as an example. However, in the exemplary embodiment, it is not limited to DHCP. The host configuration protocol has to be a kind of protocol which dynamically gives one network address from the specific network address space. For example, the host configuration protocol may be BOOTP (Bootstrap Protocol).

The invention of the present application has been described above with reference to the exemplary embodiment. However, the invention of the present application is not limited to the above mentioned exemplary embodiment. Various changes in the configuration or details of the invention of the present application that can be understood by those skilled in the art can be made without departing from the scope of the invention of the present application.

This application claims priority based on Japanese Patent Application No. 2012-188521, filed on Aug. 29, 2012, the disclosure of which is hereby incorporated by reference in its entirety.

### REFERENCE SIGNS LIST

906 internal bus

1. A network monitoring system characterized by comprising:
a communication device which includes
a host configuration server for providing network configuration information including a network address belonging to a network address space shared by an entire network to a network node connected to one subnet,
information setting unit for configuration information that collects and sets management information of the network node,
a management manager for transmitting a request for the management information to the network node, receiving a response from the network node, and receiving a notification of update of the management information from the network node, and
a management agent for receiving the request from the network management system which manages the management information, transmitting the response to the network management system, and transmitting the notification to the network management system;
the network management system which acts as the management manager to the communication device and identifies each of a plurality of the network nodes by using an identifier other than a network address or a combination of the network address and the identifier other than the network address; and
the network node which acts both as a host configuration client that communicates with the host configuration server and as the management agent to the communication device and is identified by using the identifier other than the network address or the combination of the network address and the identifier other than the network address.

2. The network monitoring system described in claim 1 further including a router which transfers a packet addressed to a network address provided to the network node to the subnet that is a management target.

3. The network monitoring system described in claim 1 in which the network management protocol is SNMP and the host configuration server is a DHCP server.

4. The network monitoring system described in claim 1 in which management information of the network node includes a MAC address of the network node.

5. A communication device characterized by comprising:
a host configuration server for providing network configuration information including a network address belonging to a network address space shared by an entire network to a network node connected to one subnet,
information setting unit for configuration information that collects and sets management information of the network node,
a management manager for transmitting a request for the management information to the network node, receiving a response from the network node, and receiving a notification of update of the management information from the network node, and
a management agent for receiving the request from the network management system which manages the management information of the network node, transmitting the response to the network management system, and transmitting the notification to the network management system.

6. A network management method of the present invention is characterized by comprising the steps of:
providing network configuration information including a network address belonging to a network address space shared by an entire network to a network node connected to one subnet;
setting information for collecting and setting management information of the network node;
transmitting a request for the management information to the network node, receiving a response from the network node, and receiving a notification of update of the management information from the network node; and
receiving the request from the network management system which manages the management information of the network node, transmitting the response to the network management system, and transmitting the notification to the network management system.

7. (canceled)
